(19) United States
(12) Patent Application Publication
(10) Pub. No.: US 2025/0386383 A1
(43) Pub. Date: Dec. 18, 2025

(54) METHOD FOR DETERMINING THE FREQUENCY OF A CENTRAL PROCESSING UNIT AND A USER EQUIPMENT

(71) Applicant: MEDIATEK INC., Hsinchu City (TW)

(72) Inventors: Kai-Hsiang HSIEH, Hsinchu City (TW); Hao-Yun CHEN, Hsinchu City (TW); Chun-Chun CHUANG, Hsinchu City (TW); Ying-You LIN, Hsinchu City (TW)

(21) Appl. No.: 18/906,662

(22) Filed: Oct. 4, 2024

Related U.S. Application Data
(60) Provisional application No. 63/661,116, filed on Jun. 18, 2024.

(51) Int. Cl. H04W 76/10; H04B 17/318; H04W 4/38; H04W 28/02

(52) U.S. Cl. CPC H04W 76/10; H04B 17/318; H04W 4/38; H04W 28/0257

(57) ABSTRACT

A method for determining the frequency of a CPU is provided. The method includes establishing a wireless connection with a network via a transceiver of a UE. The method includes determining the CPU frequency upper bound via the CPU of the UE. The method includes increasing the frequency of the CPU, until a first parameter of the wireless connection remains the same value for a predetermined duration via the CPU. The frequency of the CPU will not be increased beyond the CPU frequency upper bound. The method includes decreasing the frequency of the CPU until a second parameter of the wireless connection changes, in response to a determination that the first parameter of the wireless connection remains the same value for the predetermined duration via the CPU.

### CROSS REFERENCE TO RELATED APPLICATIONS

This application claims priority of U.S. Provisional Application Ser. No. 63/661,116, filed on 2024 Jun. 18, the entirety of which is incorporated by reference herein.

### BACKGROUND OF THE INVENTION

### Field of the Invention

The present invention relates to a method for controlling the central processing unit, and, in particular, to a method for determining the frequency of the central processing unit.

### Description of the Related Art

When an electronic device has to transmit a large amount of data, the frequency of the central processing unit (CPU) of the electronic device will be increased in order to achieve a higher throughput. However, the temperature of the electronic device will increase after the frequency of the CPU is increased. Especially, for the handheld devices or devices close to body, the temperature raises faster because of their small size. To prevent users from experiencing high temperature, the over-temperature protection mechanism of the electronic device will be triggered after the temperature of the electronic device is higher than a threshold. The frequency of the CPU will be decreased after the over-temperature protection mechanism is triggered. As a result, the throughput of the electronic device will be reduced, and it takes a long time to transmit the data. Furthermore, the high temperature will increase the power consumption of the electronic device, draining the battery. The long transmission time, the high temperature, and the high power consumption negatively influence the overall user experience.

Thus, determining the proper CPU frequency for the electronic device is vital to improve the user experience.

### BRIEF SUMMARY OF THE INVENTION

An embodiment of the present invention provides a method for determining the frequency of a central processing unit and determining which central processing unit core is going to be used. The method comprises establishing a wireless connection with a network via a transceiver of a user equipment (UE). The method further comprises determining a CPU frequency upper bound via a central processing unit (CPU) of the UE. In some embodiments, the CPU frequency upper bound is determined based on the maximum Wi-Fi capability. For example, for the Wi-Fi 5 with 2*2 multiple-input-multiple-output (MIMO), the maximum bandwidth is 160 MHz, the maximum modulation and coding scheme (MCS) is 9, and the maximum throughput is 2 Gbps. Thus, it is not necessary to boost the CPU to a frequency which is able to achieve a throughput higher than 2 Gbps, and the CPU frequency upper bound may be the frequency which is able to achieve a 2 Gbps throughput. The method further comprises increasing a frequency of the CPU via the CPU, until a first parameter of the wireless connection remains the same value for a predetermined duration. The frequency of the CPU will not be increased beyond the CPU frequency upper bound. The method further comprises decreasing the frequency of the CPU until a second parameter of the wireless connection changes, in response to a determination that the first parameter of the wireless connection remains the same value for the predetermined duration via the CPU.

An embodiment of the present invention provides a user equipment (UE) comprising a transceiver and a central processing unit (CPU). The transceiver is configured to establish a wireless connection with a network. The CPU is configured to determine a CPU frequency upper bound. The CPU is further configured to increase a frequency of the CPU, until a first parameter of the wireless connection remains the same value for a predetermined duration, wherein the frequency of the CPU will not be increased beyond the CPU frequency upper bound. The CPU is further configured to decrease the frequency of the CPU until a second parameter of the wireless connection changes, in response to a determination that the first parameter of the wireless connection remains the same value for the predetermined duration.

After the throughput becomes stable (e.g. throughput remains unchanged and packet error rate (PER) is less than 1%), the frequency of the CPU is decreased. Specifically, the frequency of the CPU is decreased until the throughput decreases or the PER increases. In this way, the optimize CPU frequency and CPU core usage can be achieved.

Furthermore, the CPU may determine whether the to-be-transmitted data amount is achievable before the over-temperature protection mechanism is triggered. The CPU may also determine whether the device is located close to the user or human using wearable devices. Then, the CPU frequency upper bound may be determined based on the results of the above mentioned determinations. For example, if the device is required to have a low temperature when it is located close to the user, the throughput and the CPU frequency upper bound will be decreased in order to decrease the CPU frequency and the temperature. Alternatively, a lower throughput and CPU frequency upper bound may be applied. According to the experiment, applying the lower throughput and CPU frequency upper bound is more time saving and can achieve a lower temperature, comparing to applying the high throughput and CPU frequency upper bound.

In some embodiments, when the throughput is higher than a first threshold, the CPU determines to separate tasks into multiple workers/tasklets and dispatch the workers/tasklets to different cores. When the throughput is lower than a second threshold, the CPU determines to combine the tasks and use one of the cores to process the combined tasks.

In some embodiments, the CPU determines which core(s) of the CPU will be used to process a task. The CPU determines to use the core with the lowest process capability to process the task, when the throughput is lower than a threshold.

### BRIEF DESCRIPTION OF THE DRAWINGS

The present invention can be more fully understood by reading the subsequent detailed description and examples with references made to the accompanying drawings, wherein:

FIG. 1 is a block diagram of a user equipment (UE) according to the embodiments of the present disclosure;

FIG. 2 is a flow diagram of a method for determining the frequency of a CPU in accordance with the embodiments of the present disclosure;

FIG. 3 is a flow diagram of a method for determining the frequency of a CPU in accordance with the embodiments of the present disclosure; and

FIG. 4 is a flow diagram of a method for determining the frequency of a CPU in accordance with the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

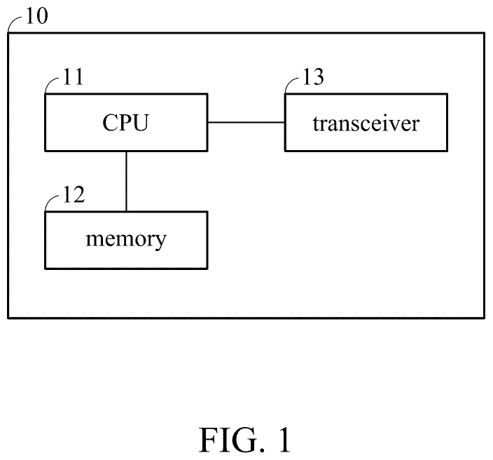

FIG. 1 is a block diagram of a user equipment (UE) 10 according to the embodiments of the present disclosure. UE 10 may perform various functions to implement processes and methods described herein. For example, UE 10 may be a mobile apparatus, a wearable apparatus, a wireless communication apparatus, or a computing apparatus. In some embodiments, UE 10 is implemented in a smartphone, a smartwatch, a tablet computer, or a notebook computer. The UE 10 comprises a central processing unit (CPU) 11, a memory 12, and a transceiver 13.

The CPU 11 controls operations of the UE 10. The CPU 11 provides the required process ability to perform operating systems, programs, software, modules, applications, and functions of the UE 10. In some embodiments, CPU 11 may be implemented in the form of hardware with electronic components including transistors, diodes, capacitors, resistors, or inductors. These components are configured and arranged to achieve specific purposes in accordance with the present disclosure. Furthermore, the CPU 11 may be implemented in the form of one or more integrated-circuit (IC) chips. In other words, the CPU 11 is a special-purpose machine specifically configured to perform specific tasks including method of the present disclosure. In some embodiments, the CPU 11 comprises multiple cores. Each of these cores has different hardware configurations and different process capabilities.

The memory 12 stores data required by the CPU 11. The memory 12 may include non-volatile memories, such as read only memory (ROM) and flash memory. The memory 12 may also include volatile memories, such as dynamic random access memory (DRAM) and static random access memory (SRAM). In some embodiments, the memory 12 stores a program (e.g. computer-readable instruction). The program can be executed by the CPU 11. When the program is executed by the CPU 11, the program causes the CPU 11 to implement methods according to the embodiments of the present disclosure.

The transceiver 13 is capable to transmit and receive data wirelessly. The transceiver 13 is coupled with one or more antennas (not shown). The transceiver 13 receives radio frequency (RF) signals from the antenna and converts RF signals to baseband signals. The transceiver 13 also converts the baseband signals to the RF signals and sends out the RF signals through the antenna.

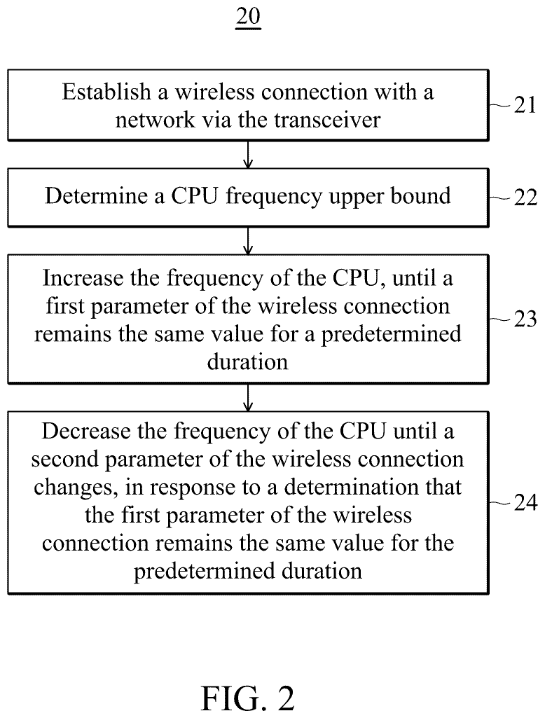

FIG. 2 is a flow diagram of a method 20 for determining the frequency of a CPU in accordance with the embodiments of the present disclosure. The method 20 can be implemented in the UE 10. In operation 21, the UE 10 establishes a wireless connection with a network via the transceiver 13. For example, the transceiver may establish the wireless connection with the network through connecting to a base station, a Wi-Fi access point, or a Wi-Fi router.

In operation 22, the CPU 11 determines a CPU frequency upper bound. In some embodiments, the CPU 11 first determines the maximum throughput of the wireless connection. Then, the CPU 11 determines the CPU frequency upper bound according to the maximum throughput of the wireless connection. The CPU frequency upper bound may be the lowest frequency of the CPU 11 required to achieve the maximum throughput.

In some embodiments, said maximum throughput is the maximum throughput that the wireless connection is able to achieve, and the CPU 11 determines the maximum throughput according to the maximum available bandwidth of the wireless connection. The wireless connection with larger available bandwidth will be determined to have higher maximum throughput. For example, when the wireless connection is established in the 2G band of Wi-Fi, the maximum available bandwidth may be 40 MHZ, and the CPU 11 may determine the maximum throughput is 600 Mbps. When the wireless connection is established in the 5G band of Wi-Fi, the maximum available bandwidth may be 160 MHZ, and the CPU 11 may determine the maximum throughput is 1.5 Gbps. When the wireless connection is established in the 6G band of Wi-Fi, the maximum available bandwidth may be 320 MHz, and the CPU 11 may determine the maximum throughput is 5 Gbps. In some embodiments, the CPU 11 may calculate the channel capacity of the wireless connection to determine the maximum throughput. In some embodiments, the maximum throughput may be determined according to the available bandwidth and previous experimental data.

In some embodiments, the CPU 11 receives indication information that indicates the maximum throughput of the wireless connection from the network via the transceiver 13. Specifically, the network may inform the UE 10 the maximum throughput of the current connection in the handshake process of the wireless connection. The throughput of the subsequent transmission between the UE 10 and network won't be larger than the maximum throughput.

After the maximum throughput is determined, the CPU 11 determines the CPU frequency upper bound according to the maximum throughput, and the CPU frequency upper bound is the lowest frequency to achieve the maximum throughput. Specifically, different CPU frequency may correspond to different throughput, and the higher CPU frequency may correspond to higher throughput. The CPU 11 may calculate the CPU frequency upper bound based on the maximum throughput. In some embodiments, the corresponding relationship of the CPU frequency and the throughput may be obtained previously through experiments or simulation and be stored in the memory 12 (e.g. in a form of a table).

In some embodiments, the CPU 11 determines that the CPU frequency upper bound is the maximum frequency of the CPU 11, when an amount of date required to be transmitted through the UE 10 is smaller than a maximum achievable throughput of the UE 10. The CPU 11 determines that the CPU frequency upper bound is a value smaller than the maximum frequency of the CPU 11, when the amount of date required to be transmitted through the UE 10 is larger than the maximum achievable throughput of the UE 10. The maximum achievable throughput of the UE 10 is the throughput achieved using the CPU 11 working at the maximum frequency of the CPU 11 before an over-temperature protection mechanism is triggered. Specifically, the temperature of the UE 10 may keep increasing while the CPU 11 is working at the maximum frequency. Then, the over-temperature protection mechanism will be triggered after the temperature of the UE 10 becomes higher than a threshold. After the over-temperature protection mechanism is triggered, the frequency of the CPU 11 is decreased. For example, the CPU 11 may achieve a throughput of N bits per second while working at the maximum frequency, and the duration between the time point that the CPU 11 starts to work at the maximum frequency and the time point that the over-temperature protection mechanism is triggered may be M seconds. The maximum achievable throughput of the UE 10 is equal to N*M.

Thus, the CPU 11 determines a lower CPU frequency upper bound, when the amount of date required to be transmitted through the UE 10 is larger than the maximum achievable throughput of the UE 10. The CPU 11 determines a higher CPU frequency upper bound, when the amount of date required to be transmitted through the UE 10 is lower than the maximum achievable throughput of the UE 10. The higher CPU frequency upper bound may allow the UE 10 to transmit/receive a large amount of data in a short time. However, the higher CPU frequency upper bound may cause the temperature of the UE 10 increase sharply and thus cause the throughput drop because of the over-temperature protection mechanism after a short period of time. On the other hand, the lower CPU frequency upper bound may keep the temperature and the throughput of the UE 10 steady and thus achieve a higher throughput in the long term (higher than the maximum achievable throughput). Thus, it is beneficial to apply a higher CPU frequency upper bound to achieve a high data rate and finish the transmission in a short time, when the required throughput is achievable by the CPU 10 with the maximum frequency before the over-temperature protection mechanism is triggered. It is beneficial to apply a lower CPU frequency upper bound to achieve a higher long-term throughput, when the required throughput isn't achievable by the CPU 10 with the maximum frequency before the over-temperature protection mechanism is triggered.

In some embodiments, the UE 10 may comprise a sensor for sensing human (or creature) close to the UE 10. For example, the UE 10 may comprise a proximity sensor, a passive infrared sensor, a capacitive sensing sensor, a specific absorption rate sensor, or a capacitive touch sensor. The CPU 11 may determine the CPU frequency upper bound is the first CPU frequency upper bound, when the sensing result of the sensor indicates that a human (or creature) is located within a predetermined distance of the UE 10. For example, the UE 10 is held in the hand. The CPU 11 may determine the CPU frequency upper bound is the second CPU frequency upper bound, when the sensing result of the sensor indicates that no human (or creature) is located within a predetermined distance of the UE 10. The first CPU frequency upper bound is lower than the second CPU frequency upper bound.

Thus, the CPU 11 determines a lower CPU frequency upper bound, when the UE is located close to the user. The CPU 11 determines a higher CPU frequency upper bound, when the UE is not located close to the user. It is beneficial to apply a higher CPU frequency upper bound to achieve a high data rate, when the UE 10 is far from human. It is beneficial to apply a lower CPU frequency upper bound to keep the temperature low, when the UE 10 is close to human. In some embodiments, the UE 10 allows the user to select the CPU frequency upper bound.

In some embodiments, the CPU 11 determines the CPU frequency upper bound according to the maximum throughput of the wireless connection, in response to the throughput of the wireless connection being higher than a threshold. In other words, the CPU 11 performs operation 22 in response to the throughput of the wireless connection being higher than the threshold.

In some embodiments, the CPU 11 further determines which core(s) of the CPU 11 will be boosted, based on the hardware configurations (or process capability) of the cores (and the maximum throughput). In the following operation 23, the CPU 11 may increase the frequency of the cores that are chosen to be boosted. Moreover, in the following operation 23, the CPU 11 does not increase the frequency of the cores that have not been chosen to be boosted. The cores of the CPU 11 may have different hardware configurations and different settings/gears (such as boost level, different settings correspond to different frequency, power consumption, and performance) and thus have different process capabilities. These hardware configurations and different settings have already been set up by the manufacturer. Thus, different cores with same frequency may achieve different throughput. The CPU 11 determines which core(s) of the CPU 11 will be boosted to ensure the total throughput achieved by the process capability of the core(s) is larger than or equal to the maximum throughput (or the desired throughput). In some embodiments, the CPU 11 further determines respective CPU frequency upper bound (and the setting) of the cores, based on the required process capability to achieve the maximum throughput (or the desired throughput) and the respective hardware configurations of the cores.

In some embodiments, the CPU determines to combine or separate the (Wi-Fi) tasks according to the throughput of the wireless connection. When the throughput is higher than a first threshold (for a non-limiting example, 4 Gbps), the CPU 11 determines to separate the tasks into multiple workers/tasklets and dispatch the workers/tasklets to different cores. In this way, the bottle-neck caused by processing the Wi-Fi task using a small part of the cores can be avoided, and the temperature of the UE 10 can also be decreased. Comparing to increasing the frequency of one core to the highest frequency, using multiple cores working at lower frequencies to process the task can decrease the power consumption and the temperature of the device. When the throughput is lower than a second threshold (for a non-limiting example, 100 Mbps), the CPU 11 determines to combine the tasks and use one of the cores to process the combined tasks. In this way, the overhead caused by switching the tasks can be decreased.

In some embodiments, the CPU 11 determines which core(s) of the CPU 11 will be used to process a task. The CPU 11 determines to use the core with the lowest process capability to process the task, when the throughput is lower than a threshold. In other words, except for adjusting the frequency, the CPU further performs the CPU core dispatching. For example, when the throughput is lower than 1 Gbps, the CPU determines to use the core with the lowest process capability to process the task, and the frequency of the core with the lowest process capability is also limited to save the power and limit the temperature.

In operation 23, the CPU 11 increases the frequency of the CPU 11, until a first parameter of the wireless connection remains the same value for a predetermined duration. The frequency of the CPU 11 is limited to be lower than the CPU frequency upper bound. In other words, the frequency of the CPU 11 will not (or cannot) be increased beyond the CPU frequency upper bound. Thus, the CPU 11 keeps increasing the frequency of the CPU 11 until the first parameter of the wireless connection remains the same value for the predetermined duration or the frequency of the CPU 11 is equal to the CPU frequency upper bound. In some embodiments, when the frequency of the CPU 11 is increased to the CPU frequency upper bound and the first parameter of the wireless connection doesn't remain the same value for the predetermined duration, the CPU 11 maintains the frequency of the CPU 11 at the CPU frequency upper bound.

Comparing to boost every core of the CPU 11 to the maximum frequency, boosting a part of the cores of the CPU 11 to a lower, designed frequency can avoid the throughput of the UE 10 decreases after a short time because of the overheat. Thus, the throughput of the UE 10 can sustain a high value over a long time. The CPU 11 monitors the first parameter to determine whether the wireless connection is stable and the throughput requirement is satisfied. When the wireless connection is stable and the throughput requirement is satisfied, the CPU 11 determines that there is no need to increase the frequency of the CPU 11.

In operation 24, the CPU 11 decreases the frequency of the CPU 11 until a second parameter of the wireless connection changes, in response to a determination that the first parameter of the wireless connection remains the same value for the predetermined duration. The CPU 11 monitors the second parameter to determine whether the stable state of the wireless connection is broken. When the wireless connection isn't stable, the CPU 11 determines to stop decreasing the frequency of the CPU 11 and increase the frequency of the CPU 11. Methods for fine-tuning the frequency in operations 23 and 24 are detailed described below.

In some embodiments, the first parameter and the second parameter of the wireless connection may be: amount of upper level packets, received signal strength indication (RSSI), the throughput, or packet error rate (PER). The first parameter and the second parameter may be the same parameter or the different parameters. The first parameter and the second parameter may be measured at the UE 10.

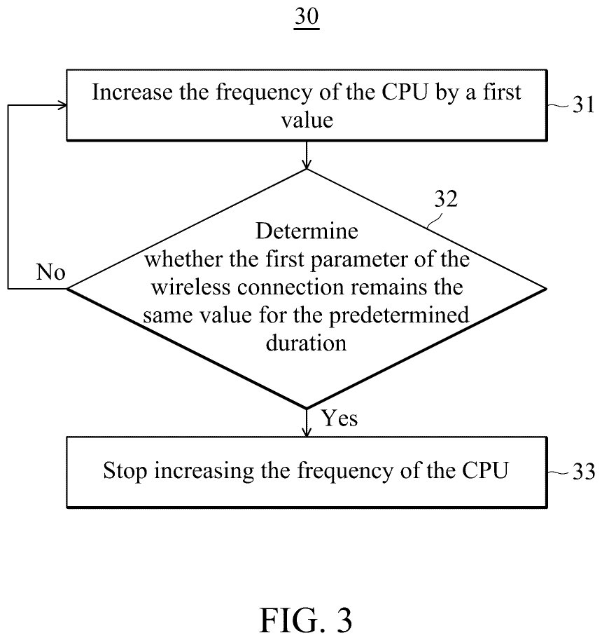

FIG. 3 is a flow diagram of a method 30 for determining the frequency of a CPU in accordance with the embodiments of the present disclosure. The method 30 can be implemented in the UE 10. The method 30 may be the method for adjusting the frequency of the CPU 11 in the operation 23. In operation 31, the CPU 11 increases the frequency of the CPU 11 by a first value. For example, the first value may be 0.2 GHz. In operation 32, the CPU 11 determines whether the first parameter of the wireless connection remains the same value for the predetermined duration. When the parameter of the wireless connection remains the same value for the predetermined duration, the CPU 11 performs operation 33. When the first parameter of the wireless connection doesn't remain the same value for the predetermined duration, CPU 11 performs operation 31. In operation 33, the CPU 11 stops increasing the frequency of the CPU 11. After operation 33, the CPU 11 may perform operation 24.

Thus, the CPU 11 determines whether the first parameter of the wireless connection remains the same value for the predetermined duration. When the first parameter of the wireless connection doesn't remain the same value for the predetermined duration, the frequency of the CPU 11 is increased by the first value, and then the CPU 11 again determines whether the first parameter of the wireless connection remains the same value for the predetermined duration. The aforementioned process is repeated until the CPU 11 determines that the first parameter of the wireless connection remains the same value for the predetermined duration.

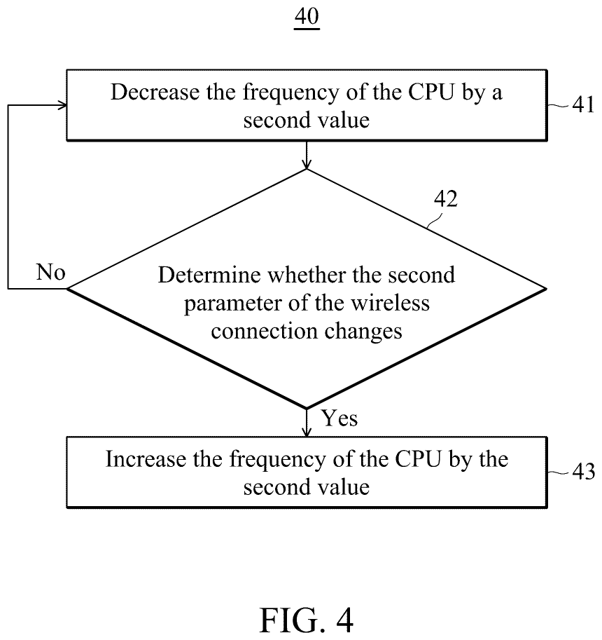

FIG. 4 is a flow diagram of a method 40 for determining the frequency of a CPU in accordance with the embodiments of the present disclosure. The method 40 can be implemented in the UE 10. The method 40 may be the method for adjusting the frequency of the CPU 11 in the operation 24. In operation 41, the CPU 11 decreases the frequency of the CPU 11 by a second value. In some embodiments, the first value is higher than the second value. For example, the second value may be 0.1 GHz or 0.05 GHz. In operation 42, the CPU 11 determines whether the second parameter of the wireless connection changes (e.g. the throughput decreases or the PER increases). When the second parameter of the wireless connection changes, the CPU 11 performs operation 43. When the second parameter of the wireless connection doesn't change (i.e. remain the same), the CPU 11 performs operation 41. In operation 43, the CPU 11 increases the frequency of the CPU 11 by the second value. After operation 43, the frequency of the CPU 11 is sustained.

Thus, the CPU 11 determines whether the second parameter of the wireless connection changes (because of the decreasing of the frequency of the CPU 11 in the operation 41). When the second parameter of the wireless connection doesn't change, the frequency of the CPU 11 is decreased by the second value, and then the CPU 11 determines whether the second parameter of the wireless connection changes again. The aforementioned process is repeated until the CPU 11 determines that the second parameter of the wireless connection changes. When the second parameter of the wireless connection changes, the frequency of the CPU 11 is increased by the second value, and this frequency is the final determined frequency.

For example, the frequency of the CPU 11 may be increased from 1 GHz to 1.2 GHz and then to 1.4 GHz, in operation 23. When the frequency of the CPU 11 is 1.4 GHZ, the CPU 11 determines that the first parameter of the wireless connection remains the same value for the predetermined duration and performs operation 24. Then, the frequency of the CPU 11 may be decreased from 1.4 GHz to 1.35 GHz and then to 1.3 GHZ, in operation 24. When the frequency of the CPU 11 is 1.3 GHZ, the CPU 11 determines that the second parameter of the wireless connection changes and increases the frequency of the CPU 11 from 1.3 GHz back to 1.35 GHz. Then, frequency of the CPU 11 sustains at 1.35 GHz.

Because the frequency of the CPU 11 increases quickly in the operation 23, the frequency of the CPU 11 might be too high after the CPU 11 determines that the wireless connection is stable. Thus, decreasing the frequency of the CPU 11 slowly in the operation 24 allows the CPU 11 to determine a frequency which is just enough to meet the throughput requirement of the wireless connection.

In some embodiments, the CPU 11 determines a new CPU frequency upper bound, in response to the amount that the throughput of the wireless connection changes being greater than a threshold. In other words, when the throughput of the wireless connection changes too much, the CPU 11 may decide to perform operation 22 again in order to adjust the frequency of the CPU.

Embodiments of the present disclosure provide a method for determining the frequency of the CPU and a UE. Embodiments of the present disclosure can keep the temperature and throughput of the UE steady through setting a CPU frequency upper bound and only boosting those of the cores of the CPU which are determined necessary to be boosted. Embodiments of the present disclosure can also find a frequency that is just enough to achieve the required throughput through decreasing the frequency of the CPU after the wireless connection becomes steady. Thus, embodiments of the present disclosure can determine a proper CPU frequency and improve the user experience.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining the frequency of a central processing unit, comprising:
establishing, via a transceiver of a user equipment (UE), a wireless connection with a network;
determining, via a central processing unit (CPU) of the UE, a CPU frequency upper bound;
increasing, via the CPU, a frequency of the CPU, until a first parameter of the wireless connection remains the same value for a predetermined duration, wherein the frequency of the CPU is limited to be lower than the CPU frequency upper bound; and
decreasing, via the CPU, the frequency of the CPU until a second parameter of the wireless connection changes, in response to a determination that the first parameter of the wireless connection remains the same value for the predetermined duration.

2. The method as claimed in claim 1, further comprising:
determining, via the CPU, a maximum throughput according to a maximum available bandwidth of the wireless connection, wherein the maximum throughput is the maximum throughput that the wireless connection is able to achieve;
determining, via the CPU, the CPU frequency upper bound according to the maximum throughput of the wireless connection, wherein the CPU frequency upper bound is the lowest frequency required to achieve the maximum throughput.

3. The method as claimed in claim 1, further comprising:
receiving, via the transceiver, an indication information that indicates a maximum throughput of the wireless connection from the network; and
determining, via the CPU, the CPU frequency upper bound according to the maximum throughput of the wireless connection, wherein the CPU frequency upper bound is the lowest frequency required to achieve the maximum throughput.

4. The method as claimed in claim 1, further comprising:
determining, via the CPU, the CPU frequency upper bound is the maximum frequency of the CPU, when an amount of date required to be transmitted through the UE is smaller than a maximum achievable throughput of the UE;
determining, via the CPU, the CPU frequency upper bound is a value smaller than the maximum frequency of the CPU, when the amount of date required to be transmitted through the UE is larger than the maximum achievable throughput of the UE;
wherein the maximum achievable throughput of the UE is the throughput achieved using the CPU working at the maximum frequency of the CPU before an over-temperature protection mechanism is triggered.

5. The method as claimed in claim 1, wherein the UE comprises a sensor for sensing human close to the UE, wherein the method further comprises:
determining, via the CPU, the CPU frequency upper bound is a first CPU frequency upper bound, when a sensing result of the sensor indicates that a human is located within a predetermined distance of the UE; and
determining, via the CPU, the CPU frequency upper bound is a second CPU frequency upper bound, when the sensing result of the sensor indicates that no human is located within the predetermined distance of the UE;
wherein the first CPU frequency upper bound is lower than the second CPU frequency upper bound.

6. The method as claimed in claim 1, wherein the operation of increasing the frequency of the CPU until the first parameter of the wireless connection remains the same value for the predetermined duration comprises:
determining, via the CPU, whether the first parameter of the wireless connection remains the same value for the predetermined duration;
increasing, via the CPU, the frequency of the CPU by a first value, and determining again whether the first parameter of the wireless connection remains the same value for the predetermined duration, in response to a determination that the first parameter of the wireless connection doesn't remain the same value for the predetermined duration;
wherein the operation of decreasing the frequency of the CPU until the second parameter of the wireless connection changes comprises:
determining, via the CPU, whether the second parameter of the wireless connection changes;
decreasing, via the CPU, the frequency of the CPU by a second value and determining whether the second parameter of the wireless connection changes again, in response to a determination that the second parameter of the wireless connection doesn't change;
increasing, via the CPU, the frequency of the CPU by the second value, in response to a determination that the second parameter of the wireless connection changes.

7. The method as claimed in claim 6, wherein the first value is higher than the second value.

8. The method as claimed in claim 1, wherein the CPU comprises multiple cores, wherein the method further comprises:
determining, via the CPU, which core(s) of the CPU will be boosted, based on hardware configurations of the cores; and
wherein the operation of increasing the frequency of the CPU until the parameter of the wireless connection remains the same value for the predetermined duration comprises:
increasing, via the CPU, the frequency of the core(s) that is determined to be boosted.

9. The method as claimed in claim 1, wherein the CPU comprises multiple cores, wherein the method further comprises:
determining, via the CPU, to separate tasks into multiple workers/tasklets and dispatch the workers/tasklets to different cores, when a throughput of the wireless connection is higher than a first threshold;
determining, via the CPU, to combine the tasks and use one of the cores to process the combined tasks, when the throughput is lower than a second threshold.

10. The method as claimed in claim 1, wherein the CPU comprises multiple cores, wherein the method further comprises:
determining, via the CPU, which core(s) of the CPU will be used to process a task; and
determining, via the CPU, to use the core with the lowest process capability to process the task, when the throughput is lower than a threshold.

11. The method as claimed in claim 1, further comprising:
determining, via the CPU, a new CPU frequency upper bound, in response to an amount that the throughput of the wireless connection changes being greater than a threshold.

12. The method as claimed in claim 1, wherein the first parameter and the second parameter of the wireless connection is: amount of upper level packets, received signal strength indication (RSSI), the throughput, or packet error rate (PER).

13. A user equipment (UE), comprising:
a transceiver, configured to establish a wireless connection with a network; and
a central processing unit (CPU), configured to:
determine a CPU frequency upper bound according;
increase a frequency of the CPU, until a first parameter of the wireless connection remains the same value for a predetermined duration, wherein the frequency of the CPU is limited to be lower than the CPU frequency upper bound; and
decrease the frequency of the CPU until a second parameter of the wireless connection changes, in response to a determination that the first parameter of the wireless connection remains the same value for the predetermined duration.

14. The UE as claimed in claim 13, wherein the CPU is further configured to:
determine a maximum throughput according to a maximum available bandwidth of the wireless connection, wherein the maximum throughput is the maximum throughput that the wireless connection is able to achieve;
determine the CPU frequency upper bound according to the maximum throughput of the wireless connection, wherein the CPU frequency upper bound is the lowest frequency required to achieve the maximum throughput.

15. The UE as claimed in claim 13, wherein the transceiver is further configured to receive an indication information that indicates a maximum throughput of the wireless connection from the network;
wherein the CPU is further configured to:
determine the CPU frequency upper bound according to the maximum throughput of the wireless connection, wherein the CPU frequency upper bound is the lowest frequency required to achieve the maximum throughput.

16. The UE as claimed in claim 13, wherein the CPU is further configured to:
determine the CPU frequency upper bound is the maximum frequency of the CPU, when an amount of date required to be transmitted through the UE is smaller than a maximum achievable throughput of the UE;
determine the CPU frequency upper bound is a value smaller than the maximum frequency of the CPU, when the amount of date required to be transmitted through the UE is larger than the maximum achievable throughput of the UE;
wherein the maximum achievable throughput of the UE is the throughput achieved using the CPU working at the maximum frequency of the CPU before an over-temperature protection mechanism is triggered.

17. The UE as claimed in claim 13, wherein the UE further comprises a sensor for sensing human close to the UE, wherein the CPU is further configured to:
determine the CPU frequency upper bound is a first CPU frequency upper bound, when a sensing result of the sensor indicates that a human is located within a predetermined distance of the UE; and
determine the CPU frequency upper bound is a second CPU frequency upper bound, when the sensing result of the sensor indicates that no human is located within the predetermined distance of the UE;
wherein the first CPU frequency upper bound is lower than the second CPU frequency upper bound.

18. The UE as claimed in claim 13, wherein the operation of increasing the frequency of the CPU until the first parameter of the wireless connection remains the same value for the predetermined duration comprises:
determining, via the CPU, whether the first parameter of the wireless connection remains the same value for the predetermined duration;
increasing, via the CPU, the frequency of the CPU by a first value, and determining again whether the first parameter of the wireless connection remains the same value for a predetermined duration, in response to a determination that the first parameter of the wireless connection doesn't remain the same value for a predetermined duration;
wherein the operation of decreasing the frequency of the CPU until the second parameter of the wireless connection changes comprises:
determining, via the CPU, whether the second parameter of the wireless connection changes;
decreasing, via the CPU, the frequency of the CPU by a second value and determining whether second parameter of the wireless connection changes again, in response to a determination that the second parameter of the wireless connection doesn't change;
increasing, via the CPU, the frequency of the CPU by the second value, in response to a determination that the second parameter of the wireless connection changes.

19. The UE as claimed in claim 18, wherein the first value is higher than the second value.

20. The UE as claimed in claim 13, wherein the CPU comprises multiple cores, wherein the CPU is further configured to:
determine which core(s) of the CPU will be boosted, based on the hardware configurations of the cores;
wherein the operation of increasing the frequency of the CPU until the parameter of the wireless connection remains the same value for the predetermined duration comprises:
increasing, via the CPU, the frequency of the core(s) that is determined to be boosted.

21. The UE as claimed in claim 13, wherein the CPU is further configured to:
determine a new CPU frequency upper bound, in response to an amount that the throughput of the wireless connection changes being greater than a threshold.

22. The UE as claimed in claim 13, wherein the first parameter and the second parameter of the wireless connection is: amount of upper level packets, received signal strength indication (RSSI), the throughput, or packet error rate (PER).

23. The UE as claimed in claim 13, wherein the CPU comprises multiple cores, wherein the CPU is further configured to:
determine to separate tasks into multiple workers/tasklets and dispatch the workers/tasklets to different cores, when a throughput of the wireless connection is higher than a first threshold;
determine to combine the tasks and use one of the cores to process the combined tasks, when the throughput is lower than a second threshold.

24. The UE as claimed in claim 13, wherein the CPU comprises multiple cores, wherein the CPU is further configured to:
determine which core(s) of the CPU will be used to process a task; and
determine to use the core with the lowest process capability to process a task, when the throughput is lower than a threshold.
